(19) United States
(12) Patent Application Publication
(10) Pub. No.: US 2011/0177752 A1
(43) Pub. Date: Jul. 21, 2011

(54) Bendable and Twistable Support Member and Toy Animal or Cartoon Character of Using Same

(76) Inventor: Leonard Patsiner, Deerfield Beach, FL (US)

(21) Appl. No.: 12/690,162

(22) Filed: Jan. 20, 2010

(51) Int. Cl. A63H 3/46; F16M 11/20

(52) U.S. Cl. 446/382; 248/188.8

(57) ABSTRACT

The present invention relates to a bendable and twistable support member and a toy animal using same. In one embodiment, the support member comprises a plurality of first cap-shaped elements, wherein each of said plurality of first cap-shaped elements comprises an opening end and a semispherical top end which has a central hole, the semispherical top end of one first cap-shaped element being inserted into the opening end of another first cap-shaped element such that said plurality of first cap-shaped elements are stacked together. The support member also comprises a string passing through the central hole on each of said stacked plurality of first cap-shaped elements to tie up them from being undetachable.

### FIELD OF THE INVENTION

The present invention relates generally to a stuffed toy animal, and more particularly, to a support member, which is bendable and twistable into a desired shape, and a toy animal or cartoon character of using same.

### BACKGROUND OF THE INVENTION

A regular toy animal is comprised of a fabric covering having the shape of an animal or cartoon character, and stuffing material, such as cotton, sponge, rags, etc., stuffed in the covering. This kind of toy animal is favorite of people for the advantages of high softness and safeness, low cost, and attractive appearance. Another kind of toy animal is comprised of a plastic or metal framework that simulates the shape of an animal, and a fabric covering coated on the framework. However, both of these two kinds of toy animal can not provide effective play value since the toy animal always shows a fixed external appearance and pose. After playing a period of time, people will lose interest to the toy animal, especially for young children.

Therefore, a heretofore unaddressed need exists in the art to address the aforementioned deficiencies and inadequacies.

### SUMMARY OF THE INVENTION

In one aspect, the present invention relates to a bendable and twistable support member. In one embodiment, the support member comprises a plurality of first cap-shaped elements, wherein each of said plurality of first cap-shaped elements comprises an opening end and a semispherical top end which has a central hole, the semispherical top end of one first cap-shaped element being inserted into the opening end of another first cap-shaped element such that said plurality of first cap-shaped elements are stacked together. The support member also comprises a string passing through the central hole on each of said stacked plurality of first cap-shaped elements to tie up them from being undetachable.

In one embodiment, the support member further comprises a second cap-shaped element, which comprises an opening end and a semispherical top end having a central hole, wherein the opening end of the second cap-shaped element is inserted into the opening end of an outest first cap-shaped element of said plurality of first cap-shaped elements to form a stack, and the string further passes through the central hole of the second cap-shaped element to tie up it with said plurality of first cap-shaped elements.

In one embodiment, the support member further comprises two stoppers provided on two opposite terminals of the support member, wherein the two stoppers are connected to two ends of the string respectively, and the two stoppers have a size larger than a diameter of the central hole.

In another embodiment, the each of the plurality of cap-shaped elements is a metal cap.

In one embodiment, the string comprises a metal wire.

In another aspect, the present invention relates to a toy animal. In one embodiment, the toy animal comprises at least one support member coated with an outer fabric cover for simulating an appendage of the toy animal.

The support member comprises a plurality of first cap-shaped elements, wherein each of said plurality of first cap-shaped elements comprises an opening end and a semispherical top end which has a central hole, the semispherical top end of one first cap-shaped element being inserted into the opening end of another first cap-shaped element such that said plurality of first cap-shaped elements are stacked together. The support member also comprises a string passing through the central hole on each of said stacked plurality of first cap-shaped elements to tie up them from being undetachable.

In one embodiment, the support member further comprises a second cap-shaped element, which comprises an opening end and a semispherical top end having a central hole, wherein the opening end of the second cap-shaped element is inserted into the opening end of an outest first cap-shaped element of said plurality of first cap-shaped elements to form a stack, and the string further passes through the central hole of the second cap-shaped element to tie up it with said plurality of first cap-shaped elements.

In one embodiment, the support member further comprises two stoppers provided on two opposite terminals of the support member, wherein the two stoppers are connected to two ends of the string respectively, and the two stoppers have a size larger than a diameter of the central hole.

In another embodiment, the each of the plurality of cap-shaped elements is a metal cap.

In one embodiment, the string comprises a metal wire.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows a schematic diagram of a toy dog according to an embodiment of the present invention;

FIG. 2 shows a schematic diagram of construction of a support member for toy animal according to a first embodiment of the present invention;

FIG. 3 shows a schematic diagram of a support member for toy animal according to a second embodiment of the present invention;

FIG. 4 shows a schematic diagram of a bended and twisted state of the support member of FIG. 3;

FIG. 5 shows a schematic diagram of the toy dog of FIG. 1 in a posed position.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. As used in the description herein and throughout the claims that follow, the meaning of “in” includes “in” and “on” unless the context clearly dictates otherwise. Also, as used in the description herein and throughout the claims that follow, the meaning of “toy animal” include all kinds of toys simulating animals, cartoon characters, human likeness or para normal likeness, such as various plush animals, stuffed animals and toy dolls.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, the terms “comprising,” “including,” “having,” “containing,” “involving,” and the like are to be understood to be open-ended, i.e., to mean including but not limited to.

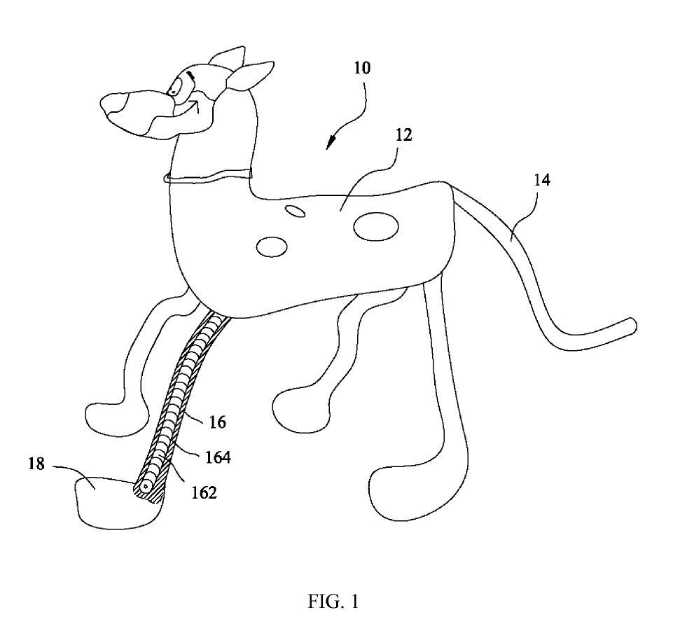

The description will be made as to the embodiments of the present invention in conjunction with the accompanying drawings of FIGS. 1-5. In accordance with the purposes of this invention, as embodied and broadly described herein, this invention, in one aspect, relates to a toy animal.

Referring now to FIG. 1, a toy animal 10 is shown according to an embodiment of the present invention. The toy animal 10 comprises a main body 12 and depending appendages, such as legs 16, feet 18 and a tail 14. At least one of the depending appendages, for example, the leg 16 shown in FIG. 1, includes an internal support member 162 and an outer fabric cover 164 coating the support member 162. The support member 162 internally supports the fabric cover 164 to present an appropriate appearance for the leg 16. In order to facilitate players to change the appearance and pose of the toy animal 10, the support member 162 is bendable and twistable into any desired shape that is retained until it is bent into another shape.

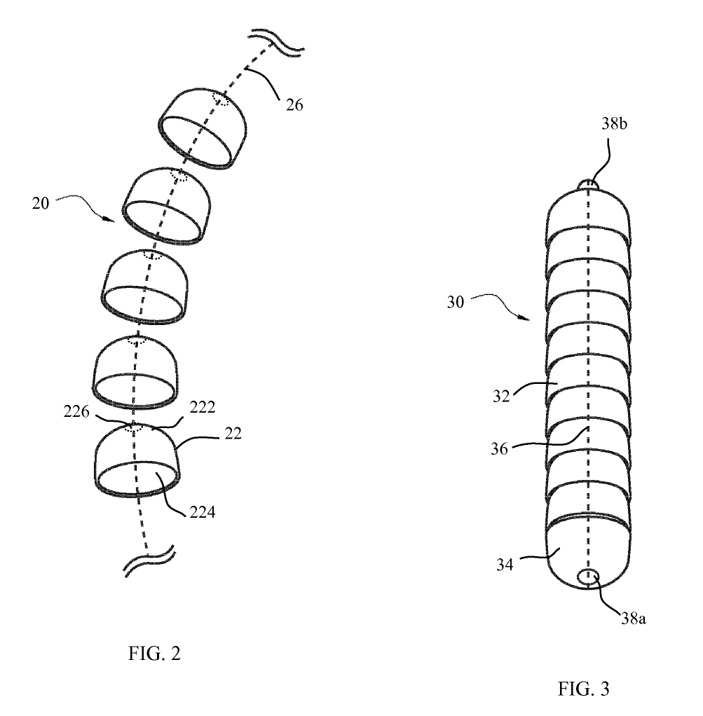

Referring to FIG. 2, a detailed construction of the support member is shown according to a first embodiment of the present invention. The support member 20 comprises a plurality of cap-shaped elements 22 stacked together and tied up by a string 26. For example, each cap-shaped element 22 may be a metal cap or a plastic cap, and the string 26 may be a metal wire or any other suitable materials. As shown in FIG. 2, each cap-shaped element 22 comprises an opening end 224 and a semispherical top end 222, and also each cap-shaped element 22 has a central hole 226 on the semispherical top end 222. The plurality of cap-shaped elements 22 can be stacked together by inserting the semispherical top end of one cap-shaped element into the opening end of another cap-shaped element, thus a stack is formed. The string 26 can pass through the central hole 226 on each of said plurality of first cap-shaped elements 22 from one end of the stack to the other end of the stack. Then the string 26 ties up all of the cap-shaped elements together from being undetachable. Therefore, the support member 20 is bendable since the cap-shaped elements 22 can be rotated between each other about the semispherical top end 222, and the support member 20 is twistable since each of the cap-shaped elements 22 can be rotated about the string 26. Also the support member 20 can be bent and twisted into any desired shape that is retained until being changed into another shape due to frictional resistance between the cap-shaped elements.

Referring now to FIG. 3, a support member 30 is shown according to a second embodiment of the present invention. In this embodiment, the support member 30 comprises a plurality of cap-shaped elements 32 stacked together, as in the support member 20 in FIG. 2. The support member 30 further comprises an additional cap-shaped element 34, which is similar to the cap-shaped elements 32. The opening end of the additional cap-shaped element 34 is inserted into the opening end of an outest one of the plurality of cap-shaped elements 32 to form a further stack and close the opening end of the outest cap-shaped element. A string 36 ties up all of the plurality of cap-shaped elements 32 and the additional cap-shaped element 34. Further, two stoppers 38a and 38b are provided on two opposite terminals of the support member 30. The two stoppers 38a and 38b are connected to two ends of the string 36 respectively, and the two stoppers 38a and 38b have a size larger than a diameter of the central hole on the cap-shaped elements such that the stacked cap-shaped elements 32 and 34 can not be detached from the string 36.

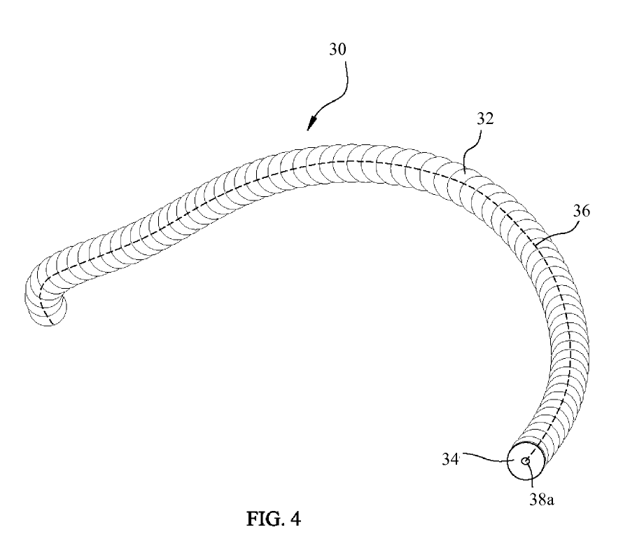

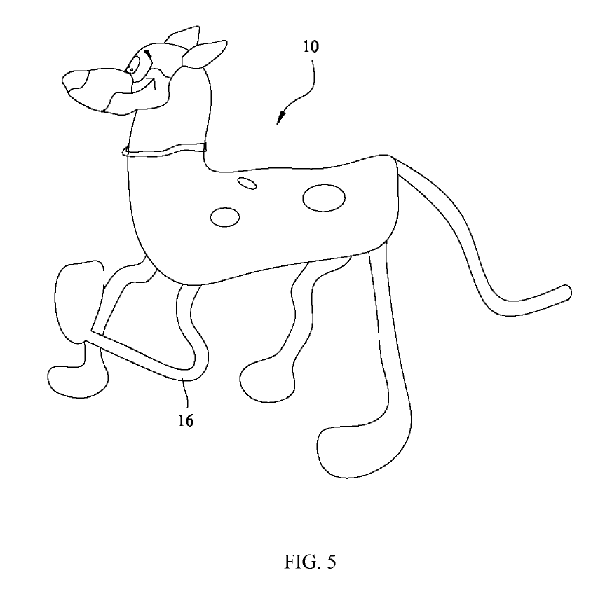

Such a support member 30 can be bent and twisted into any desired shaped. FIG. 4 shows a schematic diagram of a bended and twisted state of the support member 30. When the support member 30 is coated with a fabric cover for simulating an appendage of the toy animal, the appendage can be sewn onto the main body of the toy animal to provide more fun for the users. FIG. 5 shows the toy dog 10 of FIG. 1 in a posed position. When the support member in the leg 16 is bent into a shaped as shown in FIG. 5, the pose of the toy dog 10 is changed. People can use their imagination and creativity to create various poses for the toy dog by bending and twisting the appendages of the toy dog.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A bendable and twistable support member, comprising:
a plurality of first cap-shaped elements, wherein each of said plurality of first cap-shaped elements comprises an opening end and a semispherical top end which has a central hole, the semispherical top end of one first cap-shaped element being inserted into the opening end of another first cap-shaped element such that said plurality of first cap-shaped elements are stacked together;
a string passing through the central hole on each of said stacked plurality of first cap-shaped elements to tie up them from being undetachable.

2. The bendable and twistable support member of claim 1, further comprising a second cap-shaped element, which comprises an opening end and a semispherical top end having a central hole, wherein the opening end of the second cap-shaped element is inserted into the opening end of an outest first cap-shaped element of said plurality of first cap-shaped elements to form a stack, and the string further passes through the central hole of the second cap-shaped element to tie up it with said plurality of first cap-shaped elements.

3. The bendable and twistable support member of claim 2, further comprising two stoppers provided on two opposite terminals of the support member, wherein the two stoppers are connected to two ends of the string respectively, and the two stoppers have a size larger than a diameter of the central hole.

4. The bendable and twistable support member of claim 1, wherein each of the plurality of cap-shaped elements is a metal cap.

5. The bendable and twistable support member of claim 1, wherein the string comprises a metal wire.

6. A toy animal, comprising at least one support member coated with an outer fabric cover for simulating an appendage of the toy animal, wherein the support member comprises:
a plurality of first cap-shaped elements, wherein each of said plurality of first cap-shaped elements comprises an opening end and a semispherical top end which has a central hole, the semispherical top end of one first cap-shaped element being inserted into the opening end of another first cap-shaped element such that said plurality of first cap-shaped elements are stacked together;
a string passing through the central hole on each of said stacked plurality of first cap-shaped elements to tie up them from being undetachable.

7. The toy animal of claim 1, wherein the support member further comprises a second cap-shaped element, which comprises an opening end and a semispherical top end having a central hole, wherein the opening end of the second cap-shaped element is inserted into the opening end of an outest first cap-shaped element of said plurality of first cap-shaped elements to form a stack, and the string further passes through the central hole of the second cap-shaped element to tie up it with said plurality of first cap-shaped elements.

8. The toy animal of claim 7, wherein the support member further comprises two stoppers provided on two opposite terminals of the support member, wherein the two stoppers are connected to two ends of the string respectively, and the two stoppers have a size larger than a diameter of the central hole.

9. The toy animal of claim 1, wherein each of the plurality of cap-shaped elements is a metal cap.

10. The toy animal of claim 1, wherein the string comprises a metal wire.
